(19) United States
(12) Patent Application Publication
(10) Pub. No.: US 2006/0181399 A1
(43) Pub. Date: Aug. 17, 2006

(54) Display device for vehicle

(75) Inventor: Minoru Sumiya, Nagoya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/340,529

(22) Filed: Jan. 27, 2006

(30) Foreign Application Priority Data
Feb. 1, 2005 (JP) 2005-25395

(51) Int. Cl. B60Q 1/00; G09G 5/00

(52) U.S. Cl. 340/461; 340/438; 345/1.1

(57) ABSTRACT

A display device for a vehicle includes a first display unit, a second display unit and a control unit. The control unit controls the first display unit to display at the same time multiple indication marks indicative of respective warning items to be warned. While the first display unit displays the multiple indication marks, the control unit controls the second display unit to display a supplemental description describing at least one of the respective warning items. Here, the supplemental description supplementally explains at least one of the multiple indication marks, so that a correspondence between the supplemental description and one of the indication marks can be indicated.

### CROSS REFERENCE TO RELATED APPLICATION

This application is based on and incorporates herein by reference Japanese patent application No. 2005-25395 filed on Feb. 1, 2005.

### FIELD OF THE INVENTION

The present invention relates to a display device for a vehicle, including a first display unit for displaying multiple indication marks indicative of respective warning items, and a second display unit capable of displaying in detail multi-item meanings corresponding to the respective warning items.

### BACKGROUND OF THE INVENTION

In a conventional display device described in JP 2002-339408A, a single display unit displays an indication mark (e.g., a pictogram, a graphic design, or a symbol) having a shape and a color indicative of a warning item in combination with a supplemental message describing the warning item,.

In another conventional display device, which is described in JP H11-217030A, a single display unit is switched between a normal display mode and an abnormal display mode, and displays in the abnormal display mode information on one or more warning items each of which corresponds to an abnormity in the vehicle. When only a single abnormity causes and the display unit is switched from the normal display mode to the abnormal display mode, the display unit displays a warning item indication mark corresponding to the abnormity, in combination with a supplemental message describing the warning item. When two or more abnormities cause and the abnormal display mode is switched from the normal display mode, the display unit displays at the same time all indication marks corresponding to these abnormities without displaying the supplemental message.

The display unit in JP 2002-339408A, however, cannot quickly inform the whole picture of the multiple warning items to a user, because it displays at the same time only a single pair of an indication mark and a supplemental message which correspond to the same warning item.

In contrast, the display unit in JP H11-217030A can quickly inform the user of the whole picture of the multiple warning items, because it displays at the same time all indication marks of the multiple warning items corresponding to the abnormities. The display unit in JP H11-217030A, however, does not display the supplemental messages corresponding to the warning items together with the indication marks, and a display area of the display unit is therefore occupied by only the indication marks. The user may thus have difficulty in understanding meanings of some of the displayed indication marks or misunderstand the meanings of some of the displayed indication marks.

### SUMMARY OF THE INVENTION

It is therefore an object of the present invention to provide a display device for a vehicle which informs a user of a whole picture of multiple warning items corresponding to abnormities of the vehicle while helping the user to comprehend a supplemental description of at least one of the warning items.

A display device for a vehicle comprises a first display unit, a second display unit and a control unit. The first display unit is provided to display at the same time multiple display subjects indicative of respective warning items to be warned. The second display unit is capable of displaying supplemental descriptions of the warning items, where the supplemental descriptions are supplemental to the multiple display subjects. The control unit controls the second display unit to display at least one of the supplemental descriptions corresponding to at least one of the warning items while controlling the first display unit to display the multiple display subjects. The control unit also controls the first display unit to distinguish one of the display subjects, corresponding to the supplemental description displayed on the second display unit. With the display device, a user can recognize at the same time the whole picture of the multiple warning items causing abnormities of the vehicle while comprehending a supplemental description of at least one of the warning items.

In the display device, the first display unit can be set to blink the one of the display subjects or to change brightness of the one of display subjects, corresponding to the supplemental description displayed on the second display unit.

When plural warning items are displayed on the first display unit at the same time, the second display unit can be controlled to display the supplemental descriptions corresponding to the plural warning items, in an order based on priorities of the plural warning items. Alternatively, the second display unit can be controlled to display at least one of the supplemental descriptions in turn corresponding to the plural warning items, in an order based on priorities of the plural warning items.

The display subjects may be indication marks corresponding to the respective warning items. In this case, when plural warning items are displayed on the first display unit at the same time, the second display unit can be controlled to display in list the supplemental descriptions corresponding to the plural warning items, and to display the indication marks at predetermined positions relative to the respect supplemental descriptions, at the same time.

In the display device, the second display device can be controlled to display information related to the vehicle when no warning item to be warned is displayed in the first display device.

### BRIEF DESCRIPTION OF THE DRAWINGS

The invention, together with additional objective, features and advantages thereof, will be best understood from the following description, the appended claims and the accompanying drawings. In the drawings:

FIG. 1 is a front view of a combination meter according to an embodiment of the present invention;

FIG. 2 is a cross sectional view of the combination meter taken along the line II-II in FIG. 1;

FIG. 3 is a block diagram showing an entire control structure of the combination meter, including a controller;

FIG. 4 is a flowchart showing an overall operation of the controller;

FIG. 5 is a flowchart showing an operation of the controller for controlling a warning item display unit and a multi-function display unit according to an example of the embodiment;

FIG. 6 is a flowchart showing an operation of the controller for controlling the warning item display unit and the multi-function display unit according to another example of the embodiment; and

FIGS. 7A and 7B are examples showing item meanings displayed by the multi-function display unit.

### DETAILED DESCRIPTION OF THE EMBODIMENTS

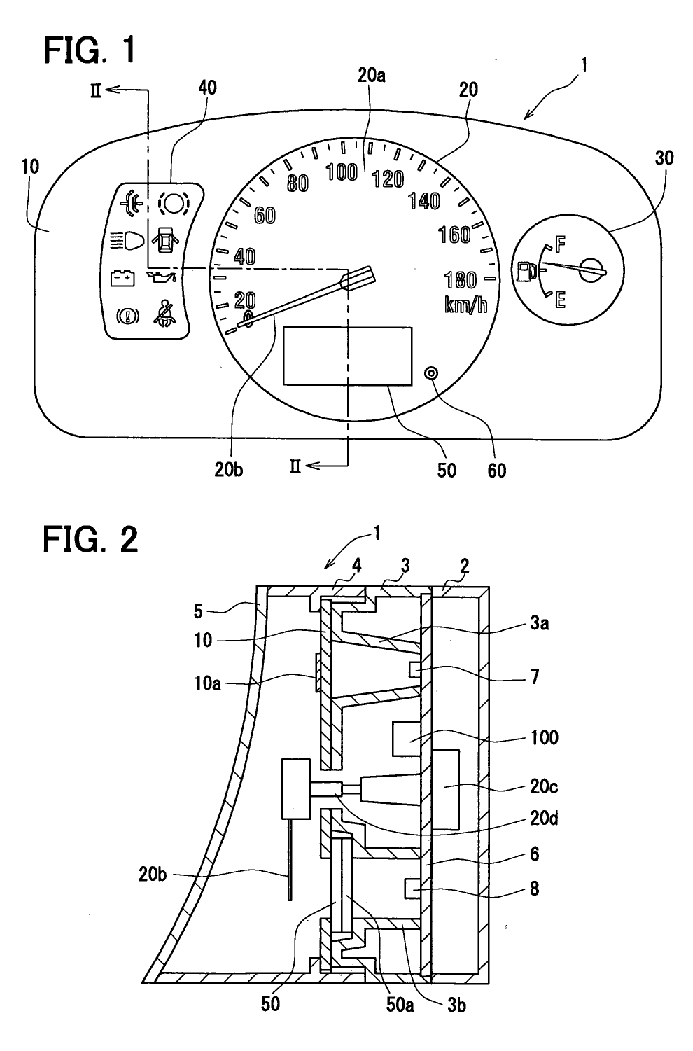

Hereafter, an embodiment of the present invention is described with reference to FIGS. 1 to 7B.

A combination meter 1 for an automobile shown in FIG. 1 is installed in a portion of an instrument panel in front of a driver's seat or in a middle portion of the instrument panel, and displays several kinds of information related to the automobile.

As shown in FIGS. 1 and 2, the combination meter 1 includes a rear case member 2, a middle case member 3, a reflector 3a, a reflector 3b, a front case member 4, a front panel 5, a printed circuit 6, light sources 7, a light source 8, an indicator panel 10, a speed indicator 20, a fuel indicator 30, a warning item display unit 40, a multi-function display unit 50, a diffusing board 50a, a columnar knob 60, and a controller 100.

In the front view shown in FIG. 1, the speed indicator 20, the fuel indicator 30, the warning item display unit 40, the multi-function display unit 50 and the columnar knob 60 are placed at positions on the indicator panel 10.

The speed indicator 20 includes a speedometer dial 20a, a dial pointer 20b, a movement 20c, and a shaft 20d. The speedometer dial 20a is provided on the indicator panel 10. For example, the letters and/or symbols are printed on the indicator panel 10 to form the speedometer dial 20a. The dial pointer 20b is rotated according to a speed of the automobile to point one of the letters or the symbols. The movement 20c is an actuator such as a step motor or a crossed coil and rotates the speedometer dial 20a by means of the shaft 20d which connects the dial pointer 20b with the shaft 20d. The fuel indicator 30 displays an amount of residual fuel in a fuel tank of the automobile.

The warning item display unit 40 has a display area which can be divided into multiple display fields. Each of the display fields is for displaying one of multiple indication marks (e.g., pictograms, graphic designs, or symbols) which are indicative of respective warning items. The warning item display unit 40 is capable of displaying at the same time any ones of the multiple indication marks.

The multi-function display unit 50 includes a liquid crystal display device which displays current date, current time, fuel efficiency, and a travel distance in a normal display mode, and displays a supplemental description of a warning item displayed by the warning item display unit 40 in an abnormal display mode. The multi-function display unit 50 serves as an odometer or a trip meter when it displays the travel distance. The columnar knob 60 is manually operated by a user to select information to be displayed by the multi-function display unit 50 and to reset a travel distance to zero.

The rear case member 2, the middle case member 3, the front case member 4 and the front panel 5 are fixed together in this order to form a main case of the combination meter 1. The case members 2 to 4 are made from resin material and the front panel 5 is made of transparent resin material. The printed circuit board 6 is fixed in the main case with its periphery inserted between the rear case member 2 and the middle case member 3. The indicator panel 10 is also fixed to the main case with its edge inserted between the middle case member 3 and the front case member 4.

The speed indicator 20, the fuel indicator 30 and the controller 100 are mounted to the printed circuit 6. The controller 100 controls the speed indicator 20, the fuel indicator 30, the warning item display unit 40 and the multi-function display unit 50. Each of the light sources 7 is mounted to the printed circuit 6 to illuminate transparently one of the display fields in the warning item display unit 40. The light source 8 is also mounted on the printed circuit 6 to illuminate transparently from behind a diffusing board 50a which is located at a rear side of the multi-function display unit 50. The light sources 7 and 8 may be made of a light emitting diode.

The reflectors 3a and 3b are integrated as a single body with the middle case member 3, are made of highly reflective resin such as white resin, and guide effectively light from the light sources 7 and 8 to the display fields and the diffusing board 50a. The diffusing board 50a diffuses the incoming light uniformly. The diffusing board 50a may be replaced with a light guide plate.

For example, appearances (e.g. shapes and colors) of the indication marks may need to be set under the rule in accordance with the warning items. In this embodiment, the warning item display unit 40 has a coloring member 10a on the indicator panel 10 to give predetermined colors in the light (which is usually white) from the light sources 7. The warning item display unit 40 may be designed so that all of the indication marks may be seen even if the light source 7 is not emitting the light. In the case that the front surface of the front panel 5 is colored to be black, all of the indication marks may be illuminated for a predetermined period after an ignition switch is turned on.

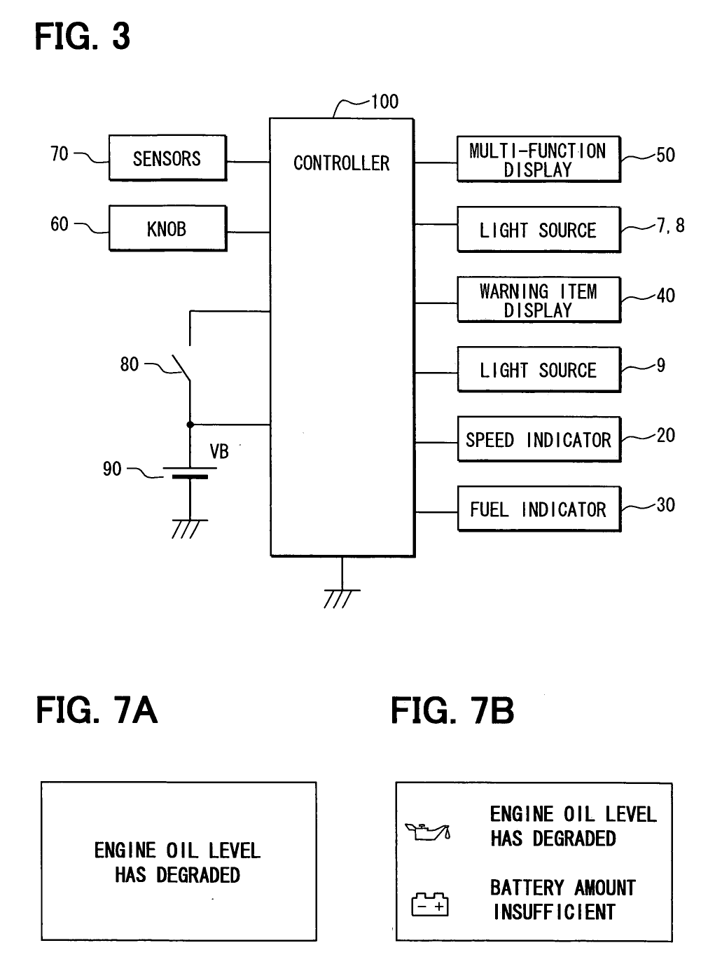

As shown in FIG. 3, the controller 100 includes a microcomputer having a CPU, a ROM and a RAM, and also includes peripheral circuits. The controller 100 receives signals from several types of sensors 70 in the automobile, including a boarding signal indicating that a person is on board, a speed signal indicating the speed of the automobile, a fuel signal indicating an amount of a residual fuel, a travel signal indicating a condition regarding travel of the automobile, and a room temperature signal indicating a temperature of the passenger compartment of the automobile. The boarding signal is outputted by a door sensor or a seating sensor. The speed signal, the fuel signal, the travel signal and the room temperature signal are used for the operations of the speed indicator 20, the fuel indicator 30, and the multi-function display unit 50.

The controller 100 also receives from the sensors 70 warning signals which are for the operation of the warning item display unit 40. The warning signals include a battery warning signal warning about decrease in battery power, an oil amount warning signal warning about decrease in an amount of engine oil, a trunk/door signal warning about opening and/or closing of a trunk and/or a door, a brake pad warning signal warning about wear of a brake pad, a seat belt warning signal warning that a seat belt has not been fastened yet, and an oil temperature warning signal warning about temperature of the engine oil.

The controller 100 also receives from the columnar knob 60 a reset signal for resetting the travel distance to zero and a switch signal for switching information to be displayed by the multi-function display unit 50.

The controller 100 executes a process based on the received signals and accordingly controls the speed indicator 20, the fuel indicator 30, the warning item display unit 40, the multi-function display unit 50, the light sources 7, and the light source 8. The controller 100 likewise controls based on the received signals a light source 9 which is for ornamental use or for illuminating the indicators 30-50.

The ROM of the controller 100 stores data indicating detailed descriptions each of which describes in detail one of the warning items and is to be displayed on the multi-function display unit 50.

As shown in FIG. 3, the controller 100 is supplied with battery voltage VB from a power supply circuit including an ignition switch 80 and a battery 90. The battery voltage VB is supplied to the controller 100 through the ignition switch 80 in the case that the ignition switch 80 is tuned on, and is supplied to the controller 100 while bypassing the ignition switch 80 in the case that the ignition switch 80 is tuned off. The controller 100 therefore operates even if the ignition switch 80 is turned off.

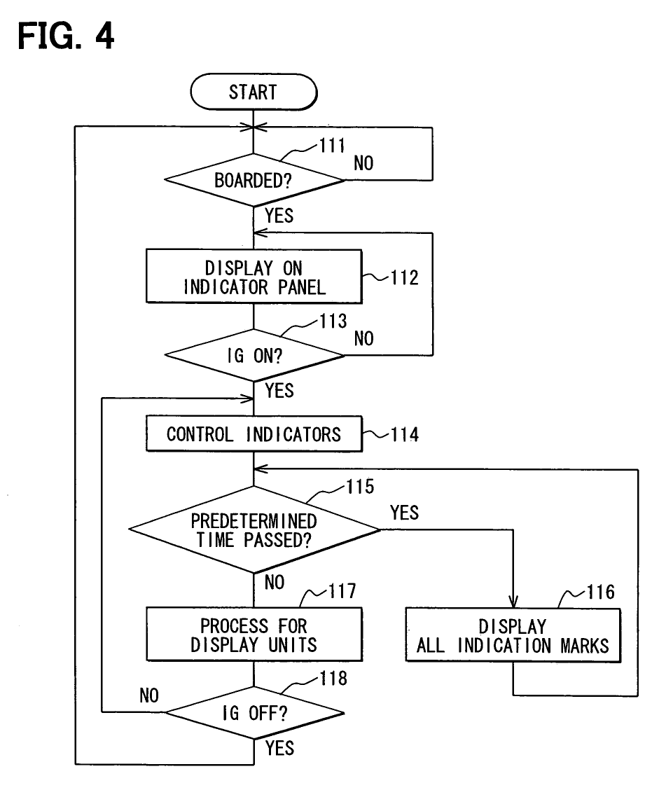

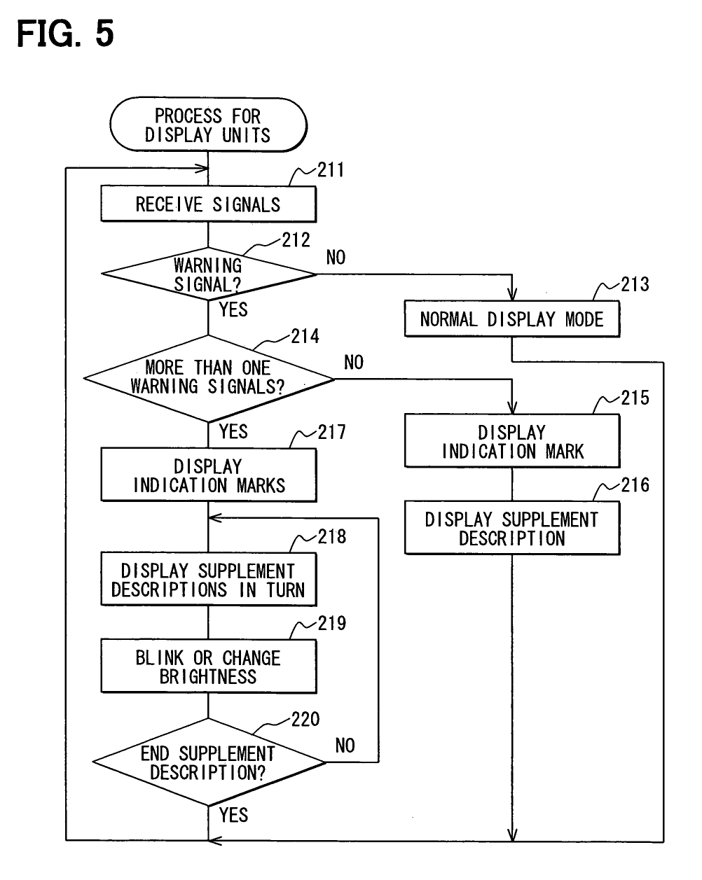

Hereafter, an operation of the controller 100 is described with reference to the flowcharts in FIGS. 4 and 5.

The controller 100 is generally always in operation because the battery voltage VB is always supplied thereto. The controller 100 controls the speed indicator 20, the fuel indicator 30, the warning item display unit 40, the multi-function display unit 50 and the light sources 7 to 9 so that they operate when the automobile is in use, that is, when the ignition switch 80 is in an ON state. In contrast, when the ignition switch 80 is in an OFF state, the operation of the controller 100 is restricted to minimum functions such as a function for counting time or a function for displaying to give a specific impression to a passenger who has just got into the automobile.

More specifically, after detecting at a step 111 that the passenger has got into the automobile, the controller 100 turns the light source 9 on and controls at a step 112 an indication of the indicator panel 10 to give the passenger the specific impression, until it detects at a step 113 that the ignition switch 80 is turned on. For example, in order to give the passenger the specific impression, the controller 100 illuminates perimeters of the speed indicator 20 and the fuel indicator 30 or controls the dial pointer 20b so that the dial pointer 20b rotates.

When the ignition switch 80 is tuned on, the controller 100 controls at a step 114 the speed indicator 20 and the fuel indicator 30 to indicate the speed and the residual fuel of the automobile, respectively. The controller 100 controls at steps 115 and 116 all the light sources 7 to illuminate all the indication marks of the warning item display unit 40 for a predetermined time after the ignition switch 80 is turned on, in order to give to the passenger a chance to check failures of the combination meter 1 such as a trouble in supplying electric power to the light source 7 or a malfunction of the warning item display unit 40.

Subsequently, the controller 100 executes at a step 117 a process for controlling the warning item display unit 40 and the multi-function display unit 50 while continuing at the step 114 controlling the speed indicator 20 and the fuel indicator 30, until it detects at a step 118 that the ignition switch 80 is turned off.

The process at the step 117 for controlling the display units 40 and 50 is illustrated in detail by the flowchart in FIG. 5. As shown in FIG. 5, the controller 100 first receives at a step 211 signals from the columnar knob 60 and the sensors 70 and makes a determination at a step 212 whether the received signals include at least one warning signal designating one of the warning items. When the determination at the step 212 is negative (NO), the controller 100 performs at a step 213 a normal display mode. In the normal display mode, the controller 100 controls the multi-function display unit 50 to display the current date, the current time, temperature in the passenger compartment, the fuel efficiency, and the travel distance. The travel distance may be displayed with a picture of an odometer or a trip meter.

When the determination at the step 212 is affirmative (YES), the controller 100 performs an abnormal display mode. In the abnormal display mode, the controller 100 first performs at a step 214 a determination whether the received signals include two or more warning signals. When the determination at the step 214 is negative, that is, if the received signals include only a single warning signal, the controller 100 controls at a step 215 the warning item display unit 40 to display an indication mark corresponding to a warning item designated by the single warning signal. In this case, the controller 100 turns on only one of the light sources 7 corresponding to one of the display fields for the designated warning item. Moreover, the controller 100 controls at a step 216 the multi-function display unit 50 to display, in place of information displayed in the normal display mode, a supplemental description (detail meaning) of the warning item designated by the single warning signal, as shown in FIG. 7A. In FIG. 7A, the display area of the multi-function display unit 50 is occupied by the supplemental description. However, the supplemental description may be displayed in combination with at least a part of the information displayed in the normal display mode.

When the determination at the step 214 is affirmative, the controller 100 controls at a step 217 the warning item display unit 40 to display all of indication marks corresponding to warning items designated by the received warning signals. In this case, the controller 100 turns on all the light sources 7 corresponding to the display fields for the designated warning items. The controller 100 thus provides information about all the situations to be warned.

Moreover, the controller 100 controls at a step 218 the multi-function display unit 50 to display multiple supplemental descriptions of the warning items designated by the received warning signals. The multiple supplemental descriptions (detail meaning) are displayed on the multi-function display unit 50 in turn (specifically one by one) at a predetermined interval in an order based on priorities predetermined for the respective warning items. While each of the supplemental descriptions is displayed, the controller 100 selects an indication mark designating the warning item corresponding to the supplemental description currently displayed, and controls at a step 219 the warning item display unit 40 to make the selected indication mark blink or to change brightness of the selected indication mark. In this case, the controller 100 controls only one of the light sources 7 corresponding to one of the display fields for the selected indication mark to blink or to change its brightness. The warning item display unit 40 thus displays the selected indication mark so that the passenger distinguishes the selected indication mark from other displayed indication marks. The passenger can therefore easily comprehend a correspondence between the supplemental description being displayed and the selected indication mark.

A predetermined order of priorities is given to each of the warning items so that a warning item has a higher priority as it becomes more significant to the safety in driving of the automobile. This is based on a concept that a need to inform of a warning item and to take a measure against the warning item becomes larger as the warning item becomes more significant to the safety in driving of the automobile.

The predetermined interval for which a supplemental description is displayed may be determined so that the passenger can recognize the meaning of the description and it still does not take much time to complete displaying all of the supplemental descriptions for the warning items to be informed. The predetermined interval may be a time period between two seconds and five seconds.

The supplemental descriptions are displayed in turn until all of the supplemental description to be displayed have been displayed once. When the affirmative determination at the step 220 is performed, the controller 100 controls the multi-function display unit 50 to stop displaying the supplemental description, while keeping the warning item display unit 40 displaying the indication marks.

The controller 100 may control the multi-function display unit 50 to display the supplemental description in turn until all of the supplemental description to be displayed have been displayed by a predetermined number of times.

Thus, in the normal display mode, the controller 100 controls the multi-function display unit 50 to display the current date, the current time, the temperature in the passenger compartment, the fuel efficiency and the travel distance. Further, in the abnormal display mode, the controller 100 controls the warning item display unit 40 and multi-function display unit 50 to display information related to the warning items. In particular, when the controller 100 receives the multiple warning signals, the controller 100 controls the warning item display unit 40 to display all of the indication marks corresponding to the received warning signals, while controlling the multi-function display unit 50 to display the supplemental descriptions corresponding to the warning signals. The passenger can thus recognize accurately and quickly all of the warning items to be informed.

It takes costs to manufacture the multi-function display unit 50 if the display unit 50 is set to display images with various colors. In this embodiment, the indication marks are displayed by the warning item display unit 40, which is separately manufactured from the multi-function display unit 50. The multi-function display unit 50 can therefore be manufactured so that it displays images with only a single color. In this case, the manufacturing cost of the combination meter 1 can be suppressed.

Moreover, the controller 100 controls the warning item display unit 40 to display a specific indication mark corresponding to the supplemental description being displayed on the multi-function display unit 50, so that the specific indication mark can be distinguished from the other displayed indication marks. For example, the specific indication mark blinks or changes its brightness on the warning item display unit 40 to be distinguished from the other displayed indication marks. Thus, the passenger can recognize quickly the multiple warning items and their meanings.

The present invention should not be limited to the embodiment discussed above and shown in the figures, but may be implemented in various ways without departing from the spirit of the invention.

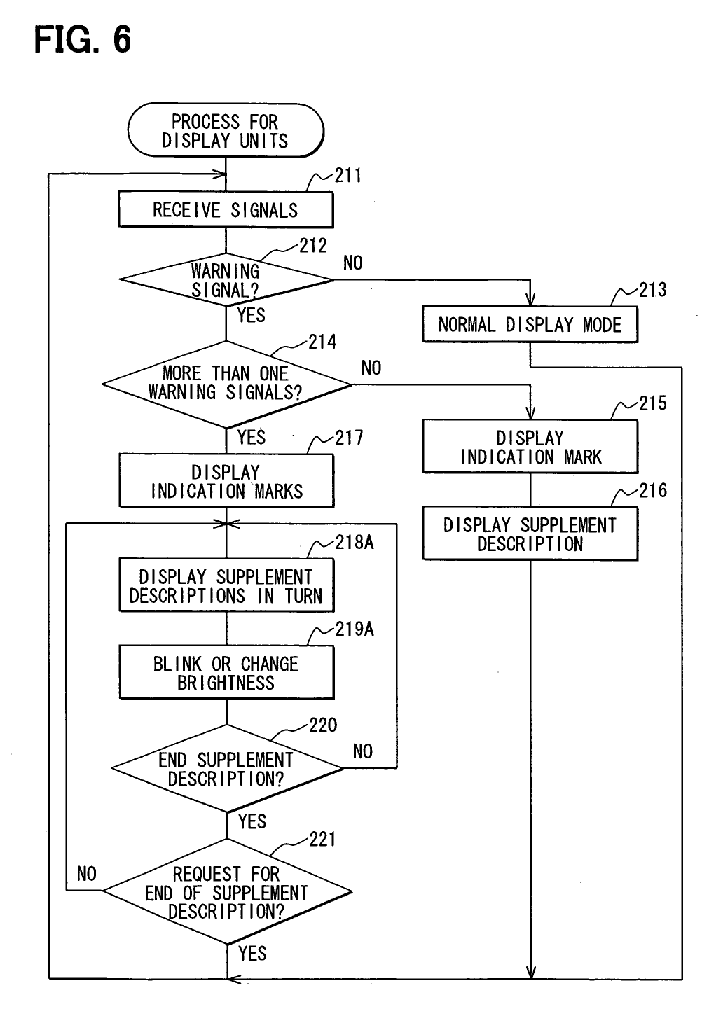

For example, time to take to display all of the supplemental descriptions to be informed can be shortened, if the controller 100 executes the process shown in FIG. 6 in place of the process in FIG. 5. Moreover, in the example of FIG. 6, the controller 100 controls the multi-function display unit 50 to stop displaying the supplemental description when receiving a request for stopping the displaying from the passenger.

The flowchart in FIG. 6 is different from that in FIG. 5 in three aspects. The first aspect is that the controller 100 controls in the abnormal display mode the multi-function display unit 50 to display simultaneously two or more supplemental descriptions, the number of which is determined by size of the display area of the multi-function display unit 50. The second aspect is that the controller 100 controls the multi-function display unit 50 to display, as well as the multiple supplemental descriptions, indication marks corresponding to the multiple supplemental descriptions, at predetermined positions relative to the respective supplemental descriptions. The third aspect is that the controller 100 controls, based on a request from a passenger, the multi-function display unit 50 to stop displaying the supplemental descriptions.

More specifically, the controller 100 controls at a step 218A the multi-function display unit 50 to display plural supplemental descriptions (e.g., two) in the multiple supplemental descriptions at the same time, in turn at a predetermined interval in an order based on the predetermined priorities for the respective warning items. In this case, the controller 100 also controls the multi-function display unit 50 to display, as well as the multiple supplemental descriptions, the indication marks corresponding to the multiple supplemental descriptions, at positions just to the left (or right) of the respective supplemental descriptions, as shown in FIG. 7B. Thus, the passenger can recognize one to one correspondence between the multiple supplemental descriptions and the indication marks simultaneously displayed on the multi-function display unit 50.

The controller 100 subsequently selects indication marks designating warning items corresponding to the supplemental descriptions currently displayed, and controls at a step 219A the warning item display unit 40 so that the selected indication marks blink or change their brightness. The passenger can therefore easily comprehend correspondences between the supplemental descriptions being displayed and the selected indication marks.

The supplemental descriptions are displayed in turn even after all of the supplemental description have been displayed once, until the controller 100 makes a determination at a step 221 that the passenger has requested for stopping displaying the supplemental descriptions. Thus, the passenger can surely understand the warning items corresponding to the displayed supplemental descriptions and take measure against the warning items. In FIG. 6, the other steps can be set similarly to the corresponding steps shown in FIG. 5 In the case that the multi-function display unit 50 simultaneously displays multiple supplemental descriptions and does not display the indication marks, the controller 100 may control the warning item display unit 40 and the multi-function display unit 50 so that a supplemental description displayed on the multi-function display unit 50 and an indication mark corresponding to this supplemental description blink or change their brightness in the same manner.

In addition, the display device of the present invention is applicable to any vehicle other than the automobile.

The warning item display unit 40 may be made so that it can display, as objects indicative of the respective warning items, any other multiple displaying objects (e.g., character strings) than the indication marks.

In the above embodiment, while the warning item display unit 40 is displaying the multiple indication marks, the controller 100 controls the multi-function display unit 50 to display, in turn in the order based on the predetermined priorities, multiple supplemental descriptions corresponding to the respective warning items.

Therefore, even if the display area of the multi-function display unit 50 is small, the multi-function display unit 50 can display all the supplemental descriptions. This increases a chance to utilize a conventional multi-function display unit 50 for displaying the supplemental descriptions corresponding to the warning items.

The controller 100 is, however, not limited to displaying the supplemental descriptions in turn. In other words, the controller 100 may just control the multi-function display unit 50 to display at the same time the multiple supplemental descriptions in a list in the order. This still informs the passenger of warning items significant to the safety of the vehicle and thereby helps the passenger take a measure for the safety.

Such changes and modifications are to be understood as being within the scope of the present invention as defined by the appended claims.

What is claimed is:

1. A display device for a vehicle, comprising:
a first display unit which is provided to display at the same time multiple display subjects indicative of respective warning items to be warned;
a second display unit capable of displaying supplemental descriptions of the warning items, the supplemental descriptions being supplemental to the multiple display subjects; and
a control unit which controls the second display unit to display at least one of the supplemental descriptions corresponding to at least one of the warning items while controlling the first display unit to display the multiple display subjects,
wherein the control unit controls the first display unit to distinguish one of the display subjects, corresponding to the supplemental description displayed on the second display unit.

2. The display device according to claim 1, wherein the control unit controls the first display unit to blink the one of the display subjects or to change brightness of the one of display subjects, corresponding to the supplemental description displayed on the second display unit.

3. The display device according to claim 1, wherein
when plural warning items are displayed on the first display unit at the same time, the control unit controls the second display unit to display the supplemental descriptions corresponding to the plural warning items, in an order based on priorities of the plural warning items.

4. The display device according to claim 1, wherein
when plural warning items are displayed on the first display unit at the same time, the control unit controls the second display unit to display at least one of the supplemental descriptions in turn corresponding to the plural warning items, in an order based on priorities of the plural warning items.

5. The display device according to claim 1, wherein:
the display subjects are indication marks corresponding to the respective warning items; and
when plural warning items are displayed on the first display unit at the same time, the control unit controls the second display unit to display in list the supplemental descriptions corresponding to the plural warning items, and to display the indication marks at predetermined positions relative to the respect supplemental descriptions, at the same time.

6. The display device according to claim 1, further comprising
a display stop member through which a passenger in the vehicle requests for the control unit to stop displaying the supplemental description,
wherein the control unit stops displaying the supplemental description when a signal from the display stop member is received.

7. The display device according to claim 1, wherein the control unit controls the second display device to display information related to the vehicle when no warning item to be warned is displayed in the first display device.
